(19) United States
(12) Patent Application Publication
(10) Pub. No.: US 2016/0078893 A1
(43) Pub. Date: Mar. 17, 2016

(54) OPTICAL INFORMATION RECORDING AND REPRODUCING DEVICE AND OPTICAL INFORMATION RECORDING AND REPRODUCING METHOD

(71) Applicant: Hitachi-LG Data Storage, Inc., Tokyo (JP)

(72) Inventor: Kouji FUJITA, Tokyo (JP)

(21) Appl. No.: 14/823,082

(22) Filed: Aug. 11, 2015

(30) Foreign Application Priority Data
Sep. 12, 2014 (JP) 2014-185881

(51) Int. Cl. G11B 7/1392

(52) U.S. Cl. CPC G11B 7/13927

(57) ABSTRACT

An optical information recording and reproducing device performs high-speed reproduction without having to sequentially change the wavelength of a reproduction light source. The device includes: a laser light source which generates a signal light and a reference light; a temperature measurement unit which measures temperature at least at two or more positions; a wavelength adjustment unit which adjusts a wavelength of the laser light source according to a result of measurement by the temperature measurement unit; a temperature distribution calculation unit which calculates a temperature distribution on the basis of the result of measurement by the temperature measurement unit; and a control unit which controls a recording operation and a reproducing operation. The control unit controls permission and prohibition of the recording operation or the reproducing operation according to the temperature distribution calculated by the temperature distribution calculation unit.

### BACKGROUND OF THE INVENTION

1. Field of the Invention

The present invention relates to an optical information recording and reproducing device and an optical information recording and reproducing method for recording information on an optical information recording medium and reproducing information from the optical information recording medium.

2. Description of the Related Art

The background art in this technical field is disclosed, for example, in JP-A-2002-216359. This literature includes the description that “the device comprises a variable wavelength coherent light source 18 which emits a reference coherent beam and a wavelength control circuit 17 which controls the wavelength of the variable wavelength coherent light source 18 on the basis of position information of a reproduced signal light on a two-dimensional photodetector array 2.”

According to JP-A-2002-216359, in order to cast a light beam from a reproduction light source onto an optical information recording medium on which information is already recorded, and then find a wavelength at which the amount of reproduction diffracted light reaches an optical value, it is necessary to sequentially search through and change the wavelength of the reproduction light source. Particularly, since the semiconductor laser and the external resonator are controlled, there is a problem that it takes some time for the light source to stabilize after the adjustment of the wavelength of the reproduction light source is started.

Also, if the wavelength of a recording light source at the time of recording on the recording medium, the temperature of the optical information recording medium and the expansion/contraction state of the medium are unknown, there is a problem that the wavelength adjustment value of the reproduction light source is unknown, requiring more time for the reproduction wavelength search operation.

### SUMMARY OF THE INVENTION

Thus, it is an object of the invention to provide an optical information recording and reproducing device and an optical information recording and reproducing method that enable reduction in the number of times the wavelength of the reproduction light source is adjusted during reproduction and thus enable high-speed reproduction.

The foregoing problems are solved by controlling the permission and prohibition of a recording operation or a reproducing operation, for example, according to temperature distribution.

Thus, an optical information recording and reproducing device and an optical information recording and reproducing method that enable reduction in the number of times the wavelength of the reproduction light source is adjusted during reproduction and thus enable high-speed reproduction, can be provided.

### BRIEF DESCRIPTION OF THE DRAWINGS

FIG. 1 shows Embodiment 1 of the invention.

FIG. 2 shows Embodiment 2 of the invention.

FIG. 3 shows Embodiment 3 of the invention.

FIG. 4 shows the relation in the arrangement between an optical information recording medium and a temperature sensor.

FIG. 5 shows the result of temperature distribution measurement on the optical information recording medium.

FIG. 6 is a flowchart in which the permission of a recording/reproducing operation is determined according to the temperature distribution on the optical information recording medium.

FIG. 7 is a flowchart in which the permission of a recording/reproducing operation is determined according to change in temperature and temperature difference in a signal optical path section and a reference optical path section.

FIG. 8 shows the overall configuration of an optical information recording and reproducing device.

### DETAILED DESCRIPTION OF THE PREFERRED EMBODIMENTS

Hereinafter, embodiments of the invention will be described with reference to the drawings.

### Embodiment 1

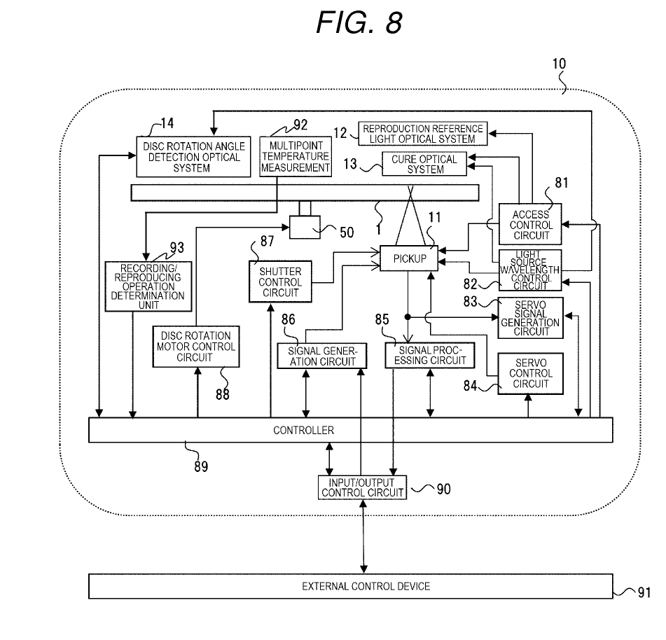

An embodiment of the invention will be described with reference to the accompanying drawings. FIG. 8 is a block diagram showing a recording and reproducing device for an optical information recording medium which records and/or reproduces digital information, using holography. An optical information recording and reproducing device 10 is connected to an external control device 91 via an input/output control circuit 90. When recording information, the optical information recording and reproducing device 10 has an information signal inputted to the input/output control circuit 90 from the external control device 91. When reproducing an information signal, the optical information recording and reproducing device 10 outputs a reproduction information signal to the external control device 91 via the input/output control circuit 90. The optical information recording and reproducing device 10 has a pickup 11, a reproduction reference light optical system 12, a cure optical system 13, a disc rotation angle detection optical system 14, and a rotation motor 50 or the like. An optical information recording medium 1 is configured to be rotatable by the rotation motor 50.

The pickup 11 casts a reference light and a signal light onto the optical information recording medium 1 and records digital information on the optical information recording medium 1, using holography. The information signal to be recorded is sent to a spatial light modulator in the pickup 11 by a controller 89 via a signal generation circuit 86, and the signal light is modulated by the spatial light modulator. When reproducing information recorded on the optical information recording medium 1, the reproduction reference light optical system 12 generates a light which causes the reference light emitted from the pickup 11 to become incident on the optical information recording medium in the direction that is opposite to the direction at the time of recording. A photodetector in the pickup 11 detects the reproduction light reproduced by the reproduction reference light, and a signal processing circuit 85 reproduces the signal. The casting time of the reference light and the signal light cast on the optical information recording medium 1 at the time of recording is adjusted by controlling the opening/closing time of a shutter which shuts off the laser beam inside the pickup 11, via a shutter control circuit 87 from the controller 89. The cure optical system 13 plays the role of generating a light beam used for pre-cure and post-cure of the optical information recording medium 1. The pre-cure refers to a pre-process in which a predetermined light is cast in advance at a recording site on the optical information recording medium 1 before the reference light and the signal light is cast at a desired position when recording information at the desired position on the optical information recording medium 1. The post-cure refers to a post-process in which a predetermined light is cast in order to disable re-recording at a desired position after information is recorded at the desired position on the optical information recording medium 1. The disc rotation angle detection optical system 14 is used to detect the rotation angle of the optical information recording medium 1. When controlling the optical information recording medium 1 to a predetermined rotation angle, the disc rotation angle detection optical system 14 detects an angle signal according to the rotation angle, and the controller 89 controls the rotation angle of the optical information recording medium 1 via a disc rotation motor control circuit 88, using the detected angle signal.

A light source wavelength control circuit 82 sets a predetermined wavelength value (for example, 405±3 nm) as light source wavelength setting information from the controller 89 and thus adjusts the laser wavelength in the pickup 11 so as to perform laser emission. A mechanism capable of moving position in radial directions of the optical information recording medium 1 is provided, thus performing positioning control of the optical information recording medium 1 in the radial directions via an access control circuit 81. In the recording and reproducing technique utilizing angle multiplexing of holography, an angle shift of the reference light that is allowed for reproduction tends to be very small. Thus, a photodetection mechanism for detecting a reference light angle at which the amount of reproduction light reaches a maximum at the time of reproduction is provided in the pickup 11. A servo signal generation circuit 83, used for the positioning of the reference light at the time of reproduction, generates a signal for servo control, and a servo mechanism for controlling the angle of the reference light via a servo control circuit 84 is provided in the optical information recording and reproducing device 10.

Next, a multipoint temperature measurement unit 92 measures the surface temperature at a plurality of positions on the optical information recording medium 1 and input temperature (for example, surface temperature) information over the entire area of the recording medium to a recording/reproducing operation determination unit 93. Here, the temperature over the entire area of the recording medium is not limited to the surface temperature and may be the temperature of the recording material, the back side temperature, or an estimated temperature calculated on the basis of the foregoing temperature. The recording/reproducing operation determination unit 93 determines the uniformity of the surface temperature of the optical information recording medium 1, and inputs a determination signal which permits a recording/reproducing operation to the controller 89 only if the temperature difference between the respective sites on the optical information recording medium 1 is equal to or below a predetermined temperature. The controller 89 controls the recording/reproducing operation of the optical information recording and reproducing device 10 according to the temperature state of the optical information recording medium 1.

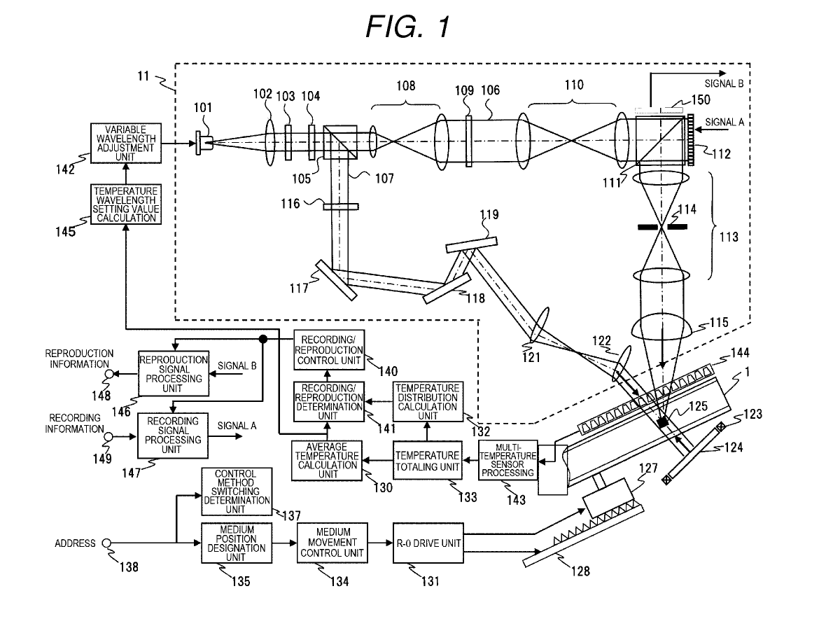

Next, FIG. 1 shows an example of the configuration of the optical system of the optical pickup 11 in the optical information recording and reproducing device 10 and the configuration for temperature detection of the optical information recording medium 1. First, the holographic recording procedure will be described. A light beam emitted from a light source 101 is transmitted through a collimating lens 102 and becomes incident on a shutter 103. When the shutter 103 is open, the light beam passes through the shutter 103 and subsequently has the direction of polarization thereof adjusted by a half-wave plate 104 in such a way that a desired light amount ratio of P-polarized light to S-polarized light is achieved. Then, the light beam becomes incident on a PBS (polarization beam splitter) prism 105. The light beam transmitted through the PBS prism 105 functions as a signal light 106, which is expanded in the light beam diameter by a beam expander 108, then is transmitted through a phase mask 109, a relay lens 110 and a PBS prism 111, and becomes incident on a spatial light modulator 112. Recording information is inputted from an input terminal 149, and a recording signal processing unit 147 generates a holographic recording signal and sends the information as a signal A to the spatial light modulator 112. The signal light with the information added by the spatial light modulator 112 passes through a relay lens 113 and a polytopic filter 114 via the PBS prism 111. The polytopic filter 114 plays the role of filtering unnecessary high-frequency light at the time of recording. Subsequently, the signal light is condensed on the optical information recording medium 1 by an objective lens 115.

Meanwhile, the light beam split by the PBS prism 105 is set as a reference light 107 in a predetermined polarization direction according to whether it is a recording operation or a reproducing operation, by a polarization conversion element 116, and subsequently becomes incident on a galvano mirror 119 via a mirror 117 and a mirror 118. The galvano mirror 119 adjusts the angle of the mirror and thus adjusts the optical axis angle of the reference light. The reference light then passes through a lens 121 and a scanner lens 122 and subsequently becomes incident on the optical information recording medium 1. As the signal light and the reference light are made to become incident in an overlapping manner on the optical information recording medium 1, an interference fringe pattern (hologram) 125 of the lights is formed. As the optical information recording medium 1 with this pattern is exposed to light, the information (page data) is recorded. Also, the incident angle of the reference light that is made incident on the optical information recording medium 1 by the galvano mirror 119 is changed, thereby performing multiplex recording of a plurality of page data at the same site on the optical information recording medium. This recording unit is called a book. The optical information recording medium 1 is rotated by a spindle motor 127, and the optical information recording medium 1 is moved in a radial direction by a radial movement stage 128 so that the recording position on the optical information recording medium 1 with respect to the objective lens 115 is changed, thereby recording the book over the entire surface of the optical information recording medium 1.

Next, the operation of moving the optical information recording medium 1 to change the hologram recording position will be described. In the movement of the optical information recording medium 1, the rotation angle (θ) and the radial position (r) of the optical information recording medium 1 are moved in association with a recording address value, thus changing the recording coordinate position. When recording address information is inputted from an input terminal 138, the recording address information is converted into the rotation angle (θ) and the radial movement position (r) of the optical information recording medium 1 by a medium position designation unit 135 and the recording coordinate position is transmitted to a medium movement control unit 134. The medium movement control unit 134 calculates a target rotation angle movement amount (Δθ) and a target radial movement amount (Δr) from the present rotation angle position (θ0) and the present radial position (r0) and transmits the result of the calculation to an r−θ drive unit 131. The r−θ drive unit 131 rotates the spindle motor 127 and carries out sled driving of the radial movement stage 128, thus performing recording positioning of the optical information recording medium 1.

Next, the relation between the temperature of the optical information recording medium 1 and the wavelength of the laser light source 101 used for recording and reproduction will be described. If a hologram recorded with a λr wavelength of the recording light source in a volume expansion/contraction state at the time of recording is to be reproduced at the time of reproduction at a different temperature from the temperature at the time of recording, that is, if the hologram is to be reproduced in a different volume expansion/contraction state of the optical information recording medium from the state at the time of recording, the reproduction diffraction intensity falls and the hologram is reproduced in the state of a distorted reproduction image (two-dimensional data) because of the wavelength selectivity of the hologram. Therefore, the data cannot be reproduced. What is important for the recording and reproduction of a hologram is to record the hologram with a predetermined laser light source wavelength corresponding to the volume expansion/contraction state of the optical information recording medium 1 and to reproduce the hologram with a predetermined laser light source wavelength corresponding to the volume expansion/contraction state of the optical information recording medium 1.

However, there is a limitation to the wavelength adjustment range of the laser light source 101. The adjustment range is as narrow as, for example, 405±3 nm. Also, to change the wavelength of the laser light source 101, it is necessary to adjust the mechanical positional relation between a laser oscillation source and an external resonator, not shown, and thus perform an adjustment operation to a predetermined laser oscillation wavelength. This operation requires an adjustment time of, for example, approximately 7 seconds in view of mechanical operation factors and laser stability. In order to reproduce a hologram at a high speed, it is important to reduce the opportunities of the wavelength change operation of the laser light source 101. If the relation between the volume expansion/contraction state with respect to the temperature of the optical information recording medium 1 and the wavelength of the laser light source 101 is, for example, 0.3 nm/° C., and the wavelength adjustment range of the laser light source 101 is, for example, 405±3 nm, reproduction is possible by adjusting the wavelength of the laser light source 101 if the medium temperature at the time of recording is up to ±10° C.

The next important point is the temperature control (temperature difference) of the medium between recording and reproduction. The optical information recording medium 1 is a removable medium. The optical information recording medium 1, not shown, are stored outside the optical information recording and reproducing device 10, and the optical information recording medium 1 is loaded in the optical information recording and reproducing device 10. Inside the casing of the optical information recording and reproducing device 10, there are heat sources such as an electronic circuit for control signal processing and an actuator for mechanical driving, and therefore the temperature is higher than in the place where the optical information recording medium 1 is stored.

For example, while the temperature inside the optical information recording and reproducing device 10 varies at individual points, temperature adjustment is carried out by an air cooling device, not shown, to around 40° C. Therefore, if the temperature in the place where the optical information recording medium 1 is stored, for example, the temperature in the server room is 25° C., the difference from the temperature of 40° C. inside the optical information recording and reproducing device 10 is 15° C. In consideration of the wavelength adjustment range of the laser light source 101 and the temperature of 40° C. inside the optical information recording and reproducing device 10, the minimum recording/reproducing operation temperature is 30° C. Therefore, even if the optical information recording medium 1 with the temperature of 25° C. is loaded in the optical information recording and reproducing device 10, a recording/reproducing operation must not be executed immediately.

Thus, in FIG. 1, the configuration to measure the temperature of the optical information recording medium 1 before carrying out a recording/reproducing operation on the optical information recording medium 1 is employed. The optical information recording medium 1 is a very simply recording medium structure having a recording material held between transparent cover layers. Since the cover layers use a glass material or resin material with a high gas barrier property, the temperature of the recording material inside the optical information recording medium 1 cannot be measured directly. The temperature of the optical information recording medium 1 is estimated on the basis of the radiation temperature on the cover layer surface. As a temperature sensor for this purpose, a radiation thermometer module 144 having a plurality of small-sized radiation temperature sensor modules arrayed in a line in a radial direction of the optical information recording medium is formed. Thus, by rotating the optical information recording medium 1, it is possible to obtain overall surface temperature information of the optical information recording medium 1.

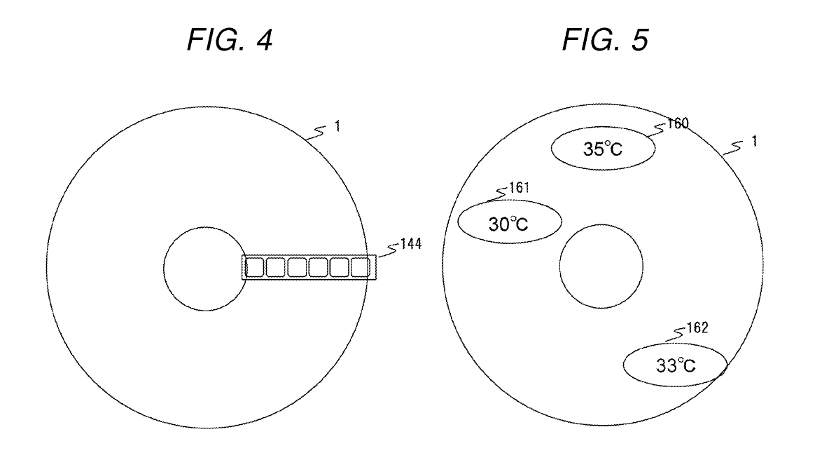

FIG. 4 shows the relation in the arrangement between the radiation thermometer module 144 arranged in a line in a radial direction of the optical information recording medium 1, and the optical information recording medium 1. A temperature sensor signal acquired by the radiation thermometer module 144 is converted to temperature information by a multi-temperature sensor processing unit 143 and then inputted to a temperature totaling unit 133. To rotate the optical information recording medium 1, an address value at which the optical information recording medium 1 makes one turn is sequentially inputted from the address input 138, thus rotationally driving the spindle motor 127. The temperature information acquired by the radiation thermometer module 144 corresponding to one turn of the optical information recording medium 1 is stored in the temperature totaling unit 133 and the overall surface temperature information of the optical information recording medium 1 is inputted to a temperature distribution calculation unit 132.

FIG. 5 shows an image of temperature distribution on the optical information recording medium 1. By carrying out the temperature measurement on the medium with the radiation thermometer module 144 corresponding to one turn of the optical information recording medium 1, it is possible to monitor the state of temperature distribution. Ideally, the temperature of the optical information recording medium 1 at the time of recording or reproduction should be uniform. It is also desirable that the temperature should be in a predetermined temperature range around a predetermined temperature, for example, 40±10° C. Meanwhile, even when the temperature is within the temperature range, if recording is carried out in the state where the temperature of the optical information recording medium 1 varies, frequent opportunities of wavelength adjustment of the laser light source 101 at the time of reproduction occur and the reproduction speed falls. Here, the operation will be described, for example, on the assumption that the temperature uniformity is defined as a temperature distribution varying by 1° C. or below, as a matter of convenience for the explanation of the operation (though the criterion of determination of the temperature uniformity of the optical information recording medium 1 need not be limited to 1° C.) Here, the temperature distribution varying by 1° C. or below means that the optical information recording medium 1 is divided into a plurality of areas and that the temperature difference between the maximum value and the minimum value of the temperatures in the divided areas is 1° C. or below. In the example of FIG. 5, this means that the temperature difference between the maximum value and the minimum value of the temperatures in respective areas 160, 161, 162 is 1° C. or below. The temperature distribution calculation unit 132 performs calculation and recognition processing on that the temperature difference between the maximum value and the minimum value of the temperatures measured by the temperature distribution calculation unit 132 for each area of the plurality of divided areas is 1° C. or below, and that there are, for example, ten or fewer areas on the optical information recording medium where the temperature difference is 1° C. or below. The result of the calculation and recognition processing is inputted to a recording/reproducing operation determination unit 141.

Meanwhile, the temperature information in the temperature totaling unit 133 is inputted to an average temperature calculation unit 130, where the average temperature over the entire surface of the optical information recording medium 1 is calculated and subsequently inputted to the recording/reproducing operation determination unit 141. The recording/reproducing operation determination unit 141 determines that the temperature distribution of the optical information recording medium 1 varies by 1° C. or below, and thus determines that temperature uniformity is secured (the average temperature of the optical information recording medium 1 falls within the range of 40±10° C. or less).

As the temperature uniformity of the optical information recording medium 1 is recognized, a permission signal for a recording or reproducing operation is inputted to a recording/reproduction control unit 140. The recording/reproduction control unit 140 performs control so that until this recording or reproducing operation is permitted, the recording or reproducing operation cannot be started even if a recording or reproduction request is inputted.

The recording/reproduction control unit 140 inputs a recording permission signal and a reproduction permission signal to the recording signal processing unit 147 and the reproduction signal processing unit 146, respectively. Also, in the wavelength adjustment of the laser light source 101, a wavelength value corresponding to the average temperature of the optical information recording medium 1 is set. For example, the temperature of the optical information recording medium is 40±10° C. and the wavelength of the laser light source 101 corresponding to this temperature is 405±3 nm. In this case, if the average temperature of the optical information recording medium 1 is 40° C., the wavelength adjustment value of the laser light source 101 is set to 405 nm. If the average temperature of the optical information recording medium 1 is 45° C., the wavelength adjustment value of the laser light source 101 is set to 405 nm+(45-40° C.)×0.3 nm=406.5 nm. The setting value calculation processing for the wavelength of the laser light source 101 is carried out by a temperature wavelength setting value calculation unit 145. The wavelength setting value of the laser light source 101 is inputted to a variable wavelength adjustment unit 142. Thus, the wavelength of the laser light source 101 is adjusted.

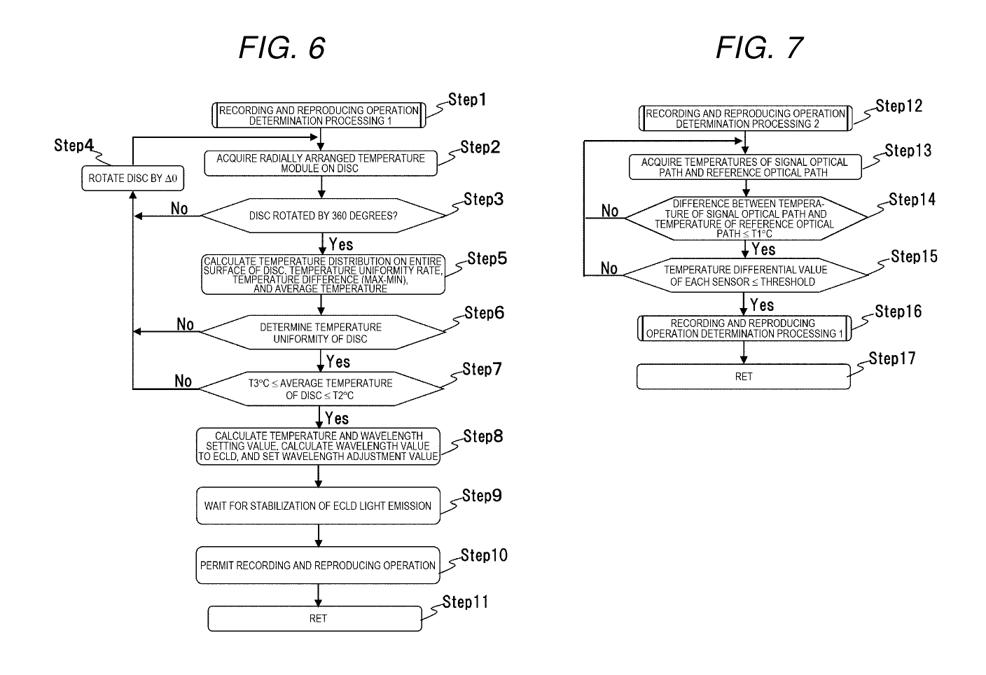

Next, the above operation will be described with reference to the flowchart of FIG. 6. This is a flow of processing in which the measurement of the temperature of the optical information recording medium and the permission or prohibition of a recording operation and a reproducing operation are carried out. The processing in the recording and reproducing operation determination processing 1 in Step 1 is carried out when the optical information recording medium is loaded in the optical information recording and reproducing device, when the power is turned on to the optical information recording and reproducing device in a cold start, when a recording operation or a reproducing operation is not carried out for a predetermined period though the power is turned on to the optical information recording and reproducing device, or when a command to execute the processing in the recording and reproducing operation determination processing is inputted to the optical information recording and reproducing device, or the like.

In the acquisition of the radially arranged temperature module on the disc in Step 2, for example, the temperature on the disc surface is acquired from the plurality of radiation thermometer sensors 144 arrayed in a line as shown in FIG. 4, and the surface temperature of the entire area of the disc can be acquired by rotating the optical information recording medium by one turn, on the basis of the determination step in Step S3 in which the disc is rotated by 360° or not, and the step of rotating the disc by Δθ in Step 4.

In Step 5, the temperature distribution over the entire surface of the disc, for example, the temperature uniformity rate, the temperature difference (max-min) and the average temperature are calculated on the basis of the above disc temperature information. To find the temperature uniformity rate, for example, a temperature contour line is formed every predetermined temperature difference, and the temperature uniformity is found on the basis of the temperature difference and the temperature distribution.

In Step 6, the temperature uniformity of the disc is determined. For example, the optical information recording medium 1 is divided into a plurality of areas, and whether the requirement that there are ten or fewer areas where the temperature difference between the maximum value and the minimum value of the temperatures in the divided areas is 1° C. or below is satisfied or not, is determined using the temperature uniformity rate or the like. This determination requirement is not limited to the above example. The recording or reproducing operation is not executed unless the temperature of the optical information recording medium 1 is determined as being uniform in this step.

In Step 7, whether the average temperature over the entire area of the disc falls within a predetermined temperature range or not is determined. Whether the average temperature is T3° C. or above and T2° C. or below (for example, 30° C. or above and 50° C. or below) is determined. The recording or reproducing operation is not executed unless the average temperature of the optical information recording medium 1 is determined as being within the predetermined temperature range in this step.

In Step 8, the calculation of the temperature and wavelength setting value is carried out and the wavelength adjustment value is set in the laser light source.

In Step 9, stabilization is waited for after the wavelength adjustment is made to the laser light source. In Step 10, the permission of the recording/reproducing operation is determined. Thus, the recording or reproducing operation can be carried out.

In Embodiment 1 as described above, recording is not carried out until the temperature of the optical information recording medium 1 becomes uniform, and recording on and reproduction from the optical information recording medium 1 can be carried out within the wavelength adjustment range of the laser light source. Therefore, the number of times the wavelength adjustment of the reproduction light source is carried out during reproduction can be reduced and high-speed reproduction can be achieved.

### Embodiment 2

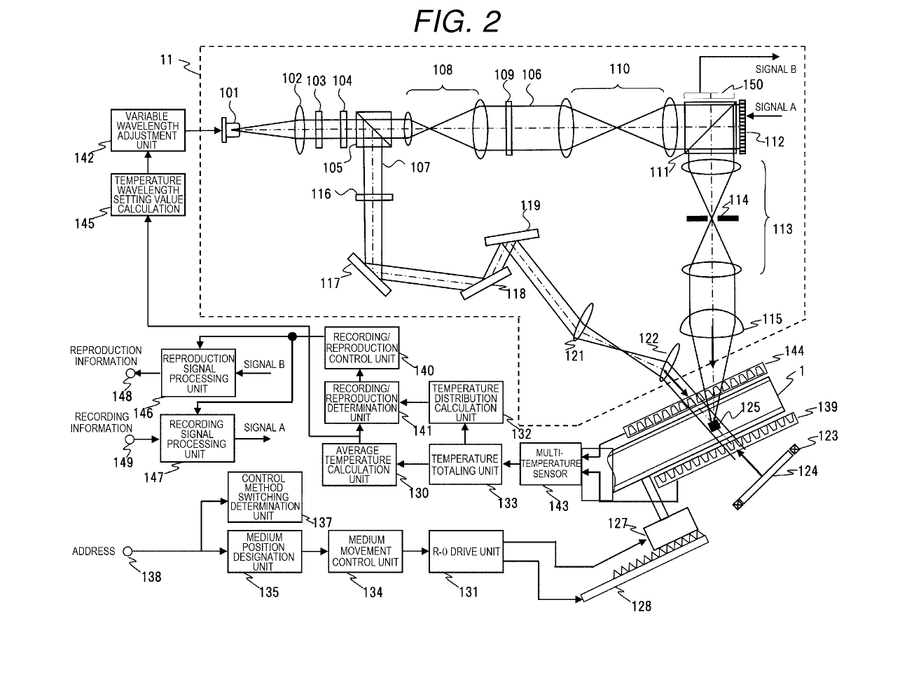

Next, a second embodiment will be described with reference to FIG. 2. The description of the same functions and processing as in Embodiment 1 is omitted. With respect to the temperature of the optical information recording medium 1, since the heat of the electronic circuit inside the optical information recording and reproducing device 10 and the heat of the mechanical drive actuator are sealed with the same casing structure, an air passage is formed inside the case and a forced air cooling unit based on a fan or the like, not shown, is provided. Therefore, the temperature around the optical information recording medium 1 is not accurately uniform, thus generating a temperature distribution on the optical information recording medium 1. The optical information recording medium 1 is, for example, a disc with a radius of 65 mm, and the temperatures on the surface side and the back side of the optical information recording medium may be different in some cases. To measure the cover layer temperatures on the surface side and the back side of the optical information recording medium 1, a radiation thermometer module 144 having a plurality of small-sized radiation thermometer modules arrayed in a line in a radial direction of the optical information recording medium is arranged on the surface side of the optical information recording medium 1, and a radiation thermometer module 139 is arranged on the back side of the optical information recording medium 1. The average value of the surface side and the back side of the optical information recording medium 1 is calculated as the temperature of the optical information recording medium 1, and the wavelength adjustment value of the laser light source 101 is thus estimated. Subsequently, the permission of a recording or reproducing operation is determined on the basis of the same functions and operations as in Embodiment 1. It is also possible to measure the cover layer temperatures on the surface side and the back side of the optical information recording medium 1 and then use the average temperature of the temperatures on the surface side and the back side, as the surface temperature of the optical information recording medium 1.

In Embodiment 2 as described above, the temperatures in the entire areas on the surface side and the back side of the optical information recording medium 1 are measured and the temperature uniformity and the average temperature are calculated on the basis of the result of the temperature measurement. Thus, the accuracy of the temperature measurement on the optical information recording medium 1 can be improved.

### Embodiment 3

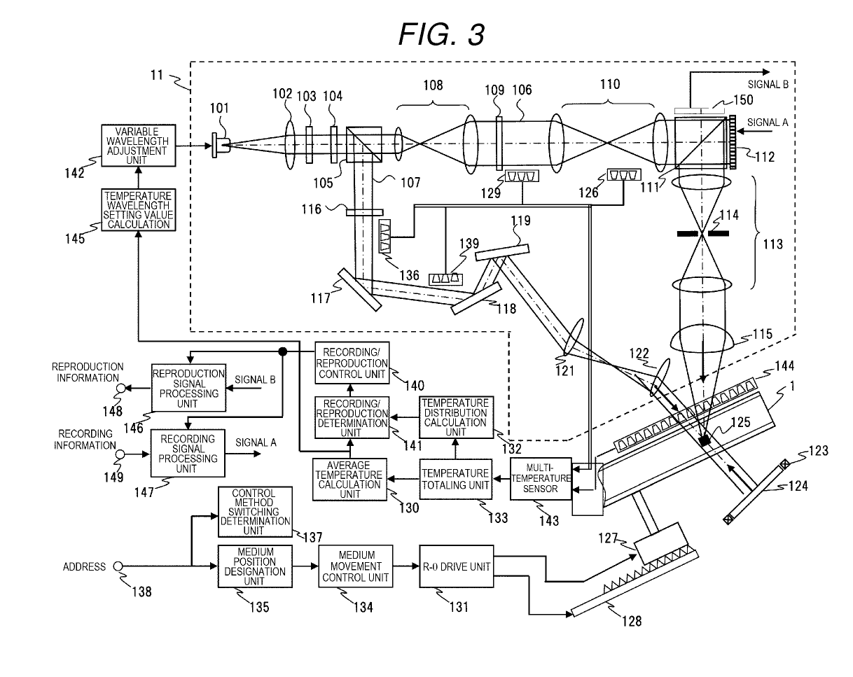

Next, a third embodiment will be described with reference to FIG. 3. The description of the same functions and processing as in Embodiment 1 is omitted. Optical interference between a signal light and a reference light is caused and a hologram is thus formed. The information of the hologram is modulated, thus performing recording of information on or reproduction of information from the optical information recording medium 1. Therefore, in the interference between the signal light and the reference light, a temperature change per unit time and a temperature distribution in the signal optical path and the reference optical path act as an external disturbance to the optical interference state, deteriorating the recording performance. That is, the occurrence of a temperature change per unit time in the optical paths during recording is a factor that causes a change in the optical path lengths of the signal light and the reference light, and consequently a distorted holographic pattern is recorded. Ideally, there should be no temperature change per unit time in the signal optical path and the reference optical path. The temperature change per unit time is referred to a temporal temperature variance.

The temporal temperature variance depends on the exposure time for recording the holographic pattern. If the exposure time is extremely short, the temporal temperature variance can be ignored. However, the exposure time for recording the holographic pattern takes a finite value, for example, 10 milliseconds to 0.3 milliseconds. Therefore, the temporal temperature variance cannot be ignored.

Thus, temperature sensors 129, 126 are provided in the signal optical path and temperature sensors 136, 139 are provided in the reference optical path, so that the permission of a recording operation can be determined, using the temperature change per unit time in the signal optical path and the reference optical path, and the acquired information of the temperature difference, as indicators. The respective temperature detection signals in the signal optical path and the reference optical path are inputted to the multi-temperature sensor 143, converted to temperature information, and inputted to the temperature totaling unit 133. The temperature totaling unit 133 gathers and stores the temperature information of each of the signal optical path and the reference optical path, on a predetermined time basis. This temperature information is inputted to the temperature distribution calculation unit 132, where the temperature differential value for each of the sensors, thus obtaining temporal temperature variance information of the signal optical path and the reference optical path. The temporal temperature variance information is inputted to the recording/reproducing operation determination unit, and if the temperature change per unit time (which occurs when a layer of hot air passes through the radiation air passage and intersects the optical path, or the like) is above a predetermined threshold, a control signal is inputted to the recording/reproduction control unit 140 so as not to perform the recording operation. The recording/reproduction control unit 140 inputs a command signal that does not permit the recording operation, to the recording signal processing unit, and inputs a prohibition signal on the recording operation to the controller 89.

FIG. 7 shows the operation flow of Embodiment 3. Step 12 is similar to Step 1 in FIG. 6 and therefore will not be described further.

In Step 13, the temperatures in the optical paths of the signal light and the reference light are acquired from the temperature sensors 126, 129, 136, 139.

In Step 14, in order to find the temperature difference between the optical path of the signal light and the optical path of the reference light, the temperature difference acquired from the temperature sensors 126 and 136 and the temperature difference acquired from the temperature sensors 129 and 139 are calculated. Then, whether the result of the calculation is equal to or below a predetermined value T1 is determined. If the result is above the predetermined value T1, the recording is not executed.

In Step 15, in order to acquire the temporal temperature variance information from the temperature sensors 126, 129, 136, 139, the temperature differential value of each temperature sensor is calculated. Then, whether the calculated temperature differential value is below a threshold is determined. If there is a temperature sensor where the calculated temperature differential value is above the threshold, the recording is not executed. The processing then shifts to Step 16.

In Embodiment 3 as described above, the permission or prohibition of the recording operation of a hologram is decided, using the temperature change per unit time in the signal optical path and the reference optical path, and the temperature difference between the signal optical path and the reference optical path, as indicators. Even if a recording request is inputted, control can be performed so as not to carry out the recording operation, for recording protection. Therefore, a highly reliable holographic pattern can be recorded on the optical information recording medium 1.

What is claimed is:

1. An optical information recording and reproducing device for recording information on an optical information recording medium and reproducing information from the optical information recording medium, the device comprising:
a laser light source which generates a signal light and a reference light;
a temperature measurement unit which measures temperature at least at two or more positions;
a wavelength adjustment unit which adjusts a wavelength of the laser light source according to a result of measurement by the temperature measurement unit;
a temperature distribution calculation unit which calculates a temperature distribution on the basis of the result of measurement by the temperature measurement unit; and
a control unit which controls a recording operation and a reproducing operation;
the control unit controlling permission and prohibition of the recording operation or the reproducing operation according to the temperature distribution calculated by the temperature distribution calculation unit.

2. The optical information recording and reproducing device according to claim 1, further comprising:
a first determination unit which determines that a temperature difference between the temperatures at the two or more positions measured by the temperature measurement unit is equal to or below a first temperature; and
a second determination unit which determines that an average temperature of the temperatures at the two or more positions measured by the temperature measurement unit is equal to or above a second temperature and equal to or below a third temperature;
wherein the control unit controls permission and prohibition of the recording operation or the reproducing operation according to a result of determination by the first determination unit and a result of determination by the second determination unit.

3. The optical information recording and reproducing device according to claim 1, wherein the temperature measurement unit measures temperature at least at two or more positions on the optical information recording medium.

4. The optical information recording and reproducing device according to claim 3, wherein the temperature measurement unit measures temperature at least at two or more positions on a surface of a cover layer of the optical information recording medium.

5. The optical information recording and reproducing device according to claim 3, wherein the temperature measurement unit measures temperature at least at two or more positions on each of a surface side and a back side of a cover layer of the optical information recording medium.

6. The optical information recording and reproducing device according to claim 3, wherein
the temperature measurement unit has:
a medium rotation unit which rotates the optical information recording medium; and
a plurality of temperature detectors arrayed along a radial direction of the optical information recording medium, and
the optical information recording medium is rotated by the medium rotation unit, thereby carrying out temperature measurement on an entire surface of the optical information recording medium.

7. The optical information recording and reproducing device according to claim 3, wherein the optical information recording medium is divided into a plurality of areas, and the control unit controls permission and prohibition of the recording operation or the reproducing operation according to the number of areas where a temperature difference between a maximum value and a minimum value of temperatures in the divided areas is equal to or below a predetermined temperature difference.

8. The optical information recording and reproducing device according to claim 5, wherein an average value of surface temperatures on the surface side and the back side of the cover layer of the optical information recording medium is used as a surface temperature of the optical information recording medium.

9. The optical information recording and reproducing device according to claim 1, wherein the temperature measurement unit measures temperature of an optical path of the signal light and an optical path of the reference light.

10. The optical information recording and reproducing device according to claim 9, wherein
the temperature measurement unit measures a temperature change per unit time, and
the control unit controls permission and prohibition of the recording operation or the reproducing operation according to whether the temperature change per unit time measured by the temperature measurement unit is above a predetermined threshold or not.

11. The optical information recording and reproducing device according to claim 10, wherein the temperature measurement unit measures a temperature difference between the temperature of the optical path of the signal light and the temperature of the optical path of the reference light.

12. An optical information recording and reproducing method in an optical information recording and reproducing device for recording information on an optical information recording medium and reproducing information from the optical information recording medium, the method comprising:
a generation step in which a signal light and a reference light are generated;
a temperature measurement step in which temperature is measured at least at two or more positions;
a wavelength adjustment step in which a wavelength of the signal light and the reference light is adjusted according to a result of measurement in the temperature measurement step;
a temperature distribution calculation step in which a temperature distribution is calculated on the basis of the result of measurement in the temperature measurement step; and
a control step in which a recording operation and a reproducing operation are controlled;
the control step including controlling permission and prohibition of the recording operation or the reproducing operation according to the temperature distribution calculated in the temperature distribution calculation step.

13. The optical information recording and reproducing method according to claim 12, further comprising:
a first determination step in which it is determined that a temperature difference between the temperatures at the two or more positions measured in the temperature measurement step is equal to or below a first temperature; and
a second determination step in which it is determined that an average temperature of the temperatures at the two or more positions measured in the temperature measurement step is equal to or above a second temperature and equal to or below a third temperature;
wherein, in the control step, permission and prohibition of the recording operation or the reproducing operation is controlled according to a result of determination in the first determination step and a result of determination in the second determination step.
